(19) United States
(12) Patent Application Publication
(10) Pub. No.: US 2023/0403750 A1
(43) Pub. Date: Dec. 14, 2023

(54) SYSTEM AND METHOD OF COMMUNICATING USING A HEADSET

(71) Applicant: 3M INNOVATIVE PROPERTIES COMPANY, St. Paul, MN (US)

(72) Inventors: Gary R. Stephany, Stillwater, MN (US); Michael G. Wurm, Waukesha, WI (US)

(21) Appl. No.: 18/249,902

(22) PCT Filed: Oct. 20, 2021
(86) PCT No.: PCT/IB2021/059682

§ 371 Date: Apr. 20, 2023

Related U.S. Application Data
(60) Provisional application No. 63/113,225, filed on Nov. 13, 2020.

(51) Int. Cl. H04W 76/14; H04W 76/15

(52) U.S. Cl. CPC H04W 76/14; H04W 76/15

(57) ABSTRACT

A method of communicating includes receiving, at a first headset, at least one input from a user. The at least one input is indicative of a request for voice communication with at least one second headset. The method further includes generating, via the first headset, a voice communication channel between the first headset and the at least one second headset upon receiving the at least one input. The method further includes generating, through the voice communication channel, a voice communication session between the first headset and the at least one second headset. The voice communication session allows voice communication between the first headset and the at least one second headset in a full-duplex communication mode.

### TECHNICAL FIELD

The present disclosure relates to a system and a method of communicating using a headset.

### BACKGROUND

Hearing protection may be used by personnel operating in noisy environments to prevent hearing damage. Although hearing protection may provide adequate protection against excessive noise, users wearing such hearing protection may need to communicate with one another. Some hearing protection may include communication devices to facilitate communication with other individuals in a noisy environment through wireless communication.

Some communication devices may typically use push-to-talk (PTT) systems that function as an audio interface for communication with other individuals. PTT systems may be activated by pressing of a button by the user. However, some working environments may not allow users to manually activate the PTT systems.

Some other communication devices may use voice-operated switches (VOX) that enable communication when voice over a certain threshold is detected. VOX may keep a communication channel open as long as voice over a certain threshold is detected. This may deplete batteries or any other power source of the communication device. Further, the user may not need the communication channel to be open every time the user speaks and not all conversations need to be transmitted through the communication channel. Also, VOX may not transmit a portion of the speech at beginning due to the nature of operation of such switches.

### SUMMARY

In one aspect, a method of communicating is described. The method includes receiving, at a first headset, at least one input from a user. The at least one input is indicative of a request for voice communication with at least one second headset. The method further includes generating, via the first headset, a voice communication channel between the first headset and the at least one second headset upon receiving the at least one input. The method further includes generating, through the voice communication channel, a voice communication session between the first headset and the at least one second headset. The voice communication session allows voice communication between the first headset and the at least one second headset in a full-duplex communication mode.

In another aspect, a system is described. The system includes a first headset including a processor and a wireless communication interface. The system further includes at least one second headset. The processor of the first headset is configured to receive at least one input from a user. The at least one input is indicative of a request for voice communication with the at least one second headset. The processor is further configured to generate, via the wireless communication interface, a voice communication channel between the first headset and the at least one second headset upon receiving the at least one input. The processor is further configured to generate, through the voice communication channel, a voice communication session between the first headset and the at least one second headset. The voice communication session allows voice communication between the first headset and the at least one second headset in a full-duplex communication mode.

In a further aspect, a headset is described. The headset includes at least one earpiece including one or more integrated speakers. The headset further includes at least one microphone coupled to the headset. The headset further includes a processor. The headset further includes a user interface communicably coupled to the processor. The user interface is configured to receive at least one input from a user. The at least one input is indicative of a request for voice communication with at least one other headset. The headset further includes a wireless communication interface communicably coupled to the processor. The wireless communication interface is configured to communicably couple the processor with the at least one other headset. The processor is configured to receive, via the user interface, the at least one input from the user. The processor is further configured to generate, via the wireless communication interface, a voice communication channel between the headset and the at least one other headset upon receiving the at least one input. The processor is further configured to generate, through the voice communication channel, a voice communication session between the headset and the at least one other headset. The voice communication session allows voice communication between the headset and the at least one other headset in a full-duplex communication mode.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic block diagram illustrating a system, in accordance with an embodiment of the present disclosure;

FIGS. 2A-2D illustrate schematic perspective views of different headsets, in accordance with various embodiments of the present disclosure;

FIG. 3 is a block diagram illustrating a system, in accordance with an embodiment of the present disclosure;

FIG. 4 is a block diagram illustrating a system, in accordance with another embodiment of the present disclosure;

FIG. 5 illustrates a plot of voice communication between a first headset and a plurality of second headsets, in accordance with an embodiment of the present disclosure;

FIG. 6 is a block diagram illustrating a system, in accordance with an embodiment of the present disclosure;

FIG. 7 illustrates a system, in accordance with an embodiment of the present disclosure;

FIG. 8 illustrates a system, in accordance with another embodiment of the present disclosure;

FIG. 9 is a flow chart illustrating a method of communicating, in accordance with an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

According to aspects of this disclosure, a method of communicating includes receiving, at a first headset, at least one input from a user. The at least one input is indicative of a request for voice communication with at least one second headset. The method further includes generating, via the first headset, a voice communication channel between the first headset and the at least one second headset upon receiving the at least one input. The method further includes generating, through the voice communication channel, a voice communication session between the first headset and the at least one second headset. The voice communication session allows voice communication between the first headset and the at least one second headset in a full-duplex communication mode.

The user of the first headset may provide the at least one input when the user wishes to connect with the at least one second headset. Thus, the user may intentionally open the voice communication channel between the first headset and the at least one second headset. By deliberately opening the voice communication channel, a full portion of a speech of the user may be transmitted through the voice communication channel as compared to communication devices that operate through VOX. Further, any accidental or unintentional transmission of the speech may be eliminated by deliberately opening the voice communication channel.

The at least one input may include a voice input by the user. This may enable communication between the first headset and the at least one second headset without the need for manual intervention as compared to PTT-based communication systems. Hence, the method of the present disclosure may allow hands-free communication between the first headset and the at least one second headset. The full-duplex communication mode may allow speech from both the first headset and the at least one second headset to be transmitted simultaneously through the communication channel. Additionally, a user of the at least one second headset may not need to manually open a transmission channel of the at least one second headset due to the full duplex communication mode. This may facilitate response from the at least one second headset.

As used herein, the term “headset” may refer to a device that includes one or more speakers, and that may, or may not, include a microphone. The headset may include any suitable type of audio headset, for example, but not limited to, headphones, over-the-ear headphones, earbuds, earbud-type headphones with ear hooks, in-ear headphones that extend partially into an ear canal, etc.

As used herein, the term “communication” may refer to any information, data, and/or signal that is provided, transmitted, received, and/or otherwise processed by an entity, and/or that is shared or exchanged between two or more people, devices, and/or other entities.

As used herein, the term “communication channel” may refer to any means of communication that enables or supports a communication interaction or an exchange of information between two or more devices or parties. The term may also refer to a shared bus configured to allow communication between two or more devices, or to a point-to-point communication link configured to allow communication between only two devices or parties.

As used herein, the term “voice communication channel” may refer to any means of communication that enables or supports a voice communication interaction between two or more devices or parties. The term may also refer to a shared bus configured to allow voice communication between two or more devices, or to a point to point communication link configured to allow voice communication between only two devices or parties.

As used herein, the term “communication session” may refer to any instance and/or occurrence of a receipt, transmittal, exchange, and/or sharing of information associated with communication between two or more parties.

As used herein, the term “voice communication session” may refer to any instance and/or occurrence of a receipt, transmittal, exchange, and/or sharing of audio information associated with communication between two or more parties.

As used herein, the terms “network” and “communication network” may be associated with transmission of messages, packets, signals, and/or other forms of information between and/or within one or more network devices. In some examples, the network may include one or more wired and/or wireless networks operated in accordance with any communication standard that is or becomes known or practicable.

As used herein, the term “duplex” may refer to a communication system composed of two or more connected parties or devices that can communicate with one another in both directions.

As used herein, the term “full-duplex” may describe that a pair of communication devices with full-duplex communication capability may transmit data or signals to each other simultaneously using a common wireless communication channel.

As used herein, the term “direct wireless communication channel” may refer to any means of communication that enables or supports a communication interaction or an exchange of information between two or more devices or parties without using a network.

As used herein, the term “transceiver” may refer to any component or group of components that is capable of at least transmitting communication signals and at least receiving communication signals.

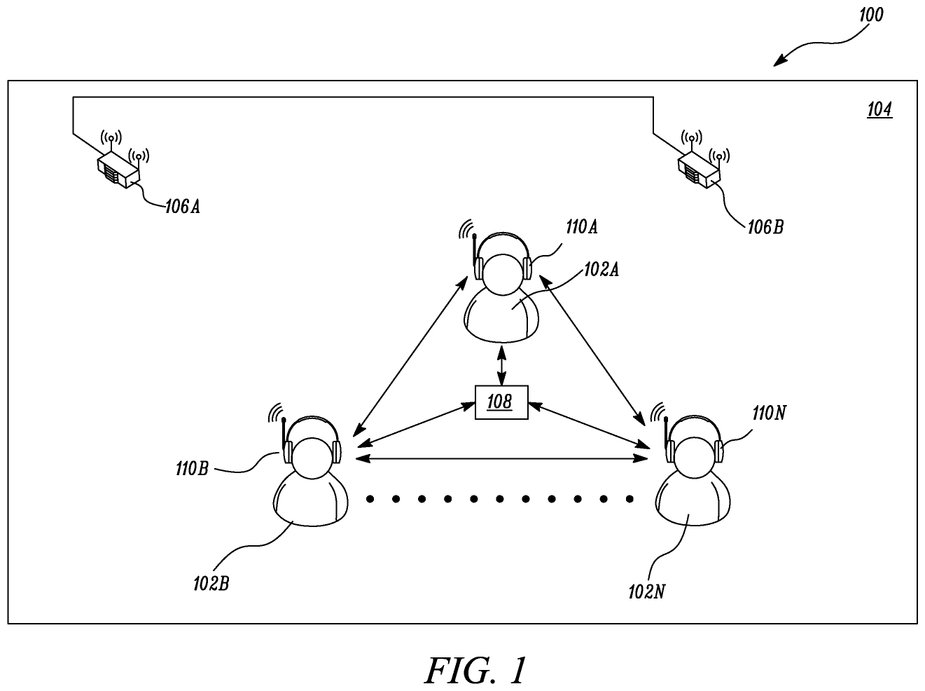

FIG. 1 is a schematic block diagram illustrating a system 100 according to an embodiment of the present disclosure. The system 100 includes one or more headsets 110A-110N (collectively, headset 110). The headsets 110A-110N may be worn by users 102A-102N (collectively, users 102).

In some examples, the headsets 110 may be used to protect the users 102 from harm or injury from a variety of factors in an ambient environment 104. In some examples, the headset 110 may be a part of a personal protective equipment (PPE) article. For example, the headset 110 may be a part of hearing protection, such as earmuffs, ear plugs, etc.

As used herein, the term “protective equipment” may include any type of equipment or clothing that may be used to protect a user from hazardous or potentially hazardous conditions. In some examples, one or more individuals, such as the users 102, may utilize the PPE article while engaging in tasks or activities within the ambient environment 104. In some examples, the PPE article may be associated with the respective users 102.

Examples of PPE articles may include, but are not limited to, respiratory protection equipment (including disposable respirators, reusable respirators, powered air purifying respirators, self-contained breathing apparatus and supplied air respirators), facemasks, oxygen tanks, air bottles, protective eyewear, such as visors, goggles, filters or shields (any of which may include augmented reality functionality), protective headwear, such as hard hats, hoods or helmets, protective shoes, protective gloves, other protective clothing, such as coveralls, aprons, coat, vest, suits, boots and/or gloves, protective articles, such as sensors, safety tools, detectors, global positioning devices, mining cap lamps, fall protection harnesses, exoskeletons, self-retracting lifelines, heating and cooling systems, gas detectors, and any other suitable gear configured to protect the users 102 from injury. The PPE articles may also include any other type of clothing or device/equipment that may be worn or used by the users 102 to protect against extreme noise levels, extreme temperatures, fire, reduced oxygen levels, explosions, reduced atmospheric pressure, radioactive and/or biologically harmful materials.

In some examples, the headset 110 may be used by emergency personnel, for example, firefighters, law enforcement, first responders, healthcare professionals, paramedics, HAZMAT workers, security personnel, or other personnel working in hazardous or potentially hazardous conditions, for example, chemical environments, biological environments, nuclear environments, fires, or other physical environments, for example, industrial sites, construction sites, agricultural sites, mining or manufacturing sites.

As used herein, the term “hazardous or potentially hazardous condition” may refer to environmental conditions that may be harmful to a human being, such as high noise levels, high ambient temperatures, lack of oxygen, presence of explosives, exposure to radioactive or biologically harmful materials, and exposure to other hazardous substances. Depending upon the type of safety equipment, environmental conditions and physiological conditions, corresponding thresholds or levels may be established to help define hazardous and potentially hazardous conditions.

In some examples, the headsets 110 may be able to send and/or receive data by way of one or more wired and/or wireless communication interfaces. For example, the headsets 110 may allow voice communication between the headsets 110A-110N. In some examples, the one or more wireless communication interfaces may include transceivers for transmitting and receiving radio signals. Each headset 110A-110N may be configured to communicate data, such as voice data, via wireless communication, such as via 802.11 Wi-Fi protocols, Bluetooth® protocols, or any other radio communication protocol.

In some examples, the transceiver may be a two-way radio, such as a land mobile radio (LMR). LMR systems are generally deployed by organizations requiring instant communication between geographically dispersed and mobile personnel. LMR systems may be configured to provide radio communications between one or more sites and subscriber radio units in the field. The subscriber radio unit may be a mobile unit or a portable unit. LMR systems may include two radio units communicating between themselves over preset channels, or they may include hundreds of radio units and multiple sites. The two-way radios may operate in full-duplex communication mode. The full-duplex communication mode may be similar to a telephone system where the receiving and transmitting paths are both open and both parties can speak to each other simultaneously.

In some examples, the transceiver may be a customized two-way radio with specialized software intended for specific users, for example, firefighters, law enforcement, etc. In some examples, the transceiver may be configured to transmit and receive audio signals, e.g., as digital or analog modulated RF signals. In an example, the transceiver may include an RF transceiver circuit coupled to an audio circuit which may include an amplifier, a microphone, an audio speaker, a volume control, and so forth. Further, the transceiver may include a manual and/or automatic frequency tuner for tuning to a desired frequency channel.

In some examples, the ambient environment 104 may include a communication network (e.g., a local area network) through which the headsets 110 may communicate with each other. For example, the ambient environment 104 may be configured with wireless technology, such as 802.11 wireless networks, 802.15 ZigBee networks, and/or the like. In the example of FIG. 1, the ambient environment 104 includes a wireless local area network (WLAN) that provides a packet-based transport medium to allow communication between the headsets 110 and/or the users 102. In addition, the ambient environment 104 includes a plurality of wireless access points 106A, 106B that may be geographically distributed throughout the ambient environment 104 to provide support for wireless communications throughout the ambient environment 104. Headsets 110 may, for example, communicate directly with each other or through the wireless access points 106A, 106B.

In some examples, the communication network may include one or more of a wireless network, a wired network, a local area network (LAN), a metropolitan area network (MAN), a wide area network (WAN), a wireless personal area network (WPAN), WiMax networks, a direct connection, such as through a Universal Serial Bus (USB) port, and/or the like, and may include a set of interconnected networks that make up the Internet. In some examples, the wireless network may include a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc. In some examples, the communication network may include a circuit-switched voice network, a packet-switched data network, or any other network capable for carrying electronic communication. For example, the communication network may include networks based on the Internet protocol (IP) or asynchronous transfer mode (ATM), etc.

Examples of the communication network may further include, but are not limited to, a personal area network (PAN), a storage area network (SAN), a home area network (HAN), a campus area network (CAN), an enterprise private network (EPN), Internet, a global area network (GAN), and so forth. Examples are intended to include or otherwise cover any type of network, including known, related art, and/or later developed technologies to connect the headsets 110 with each other.

In some examples, the headsets 110 may include various components, such as a microphone and a speaker, mounted thereon or otherwise accessible to the headsets 110 that facilitate voice communication between the headsets 110. Specifically, the headsets 110 may transmit speech data through the microphone. The transceiver may transmit the speech data through a communication channel using RF signals. In some examples, the communication channel may be a voice communication channel. Further, the headsets 110 may receive speech data through the transceiver.

The system 100 may further include a communication controller 108. In some examples, the communication controller 108 may be a part of the communication network. The communication controller 108 may be communicably coupled to the headsets 110. The communication controller 108 may control voice communication between the headsets 110. For example, the communication controller 108 may regulate a number of headsets (e.g., the headsets 110) that may participate in voice communication. The communication controller 108 may limit the number of simultaneous speakers within a workgroup. In view of this limited number of simultaneous speakers, it may prioritize communication according to a set of rules.

For example, it can prioritize safety messages or communication from supervisors.

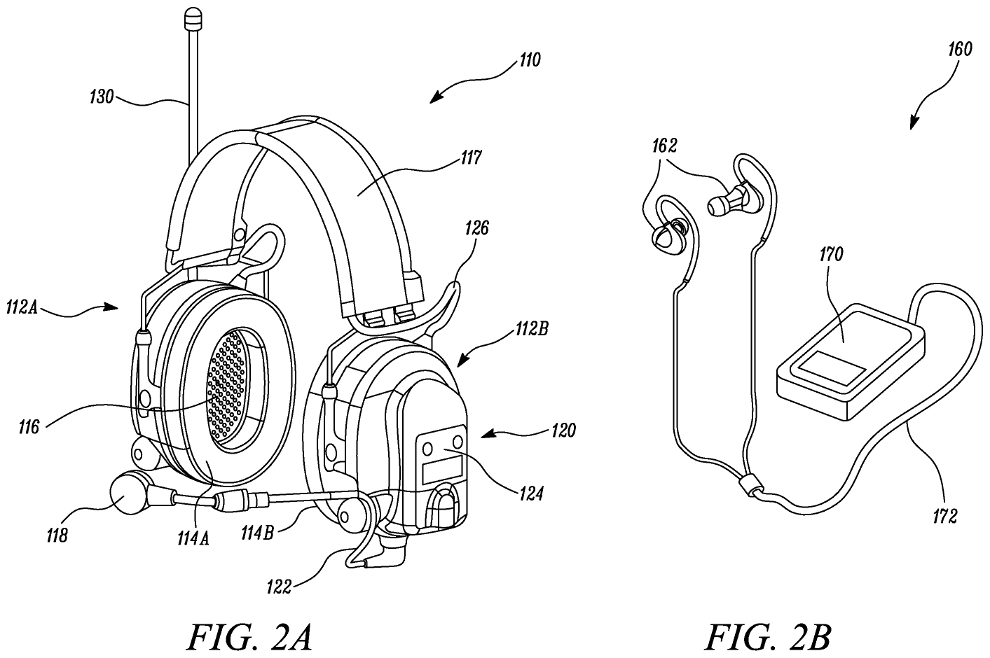

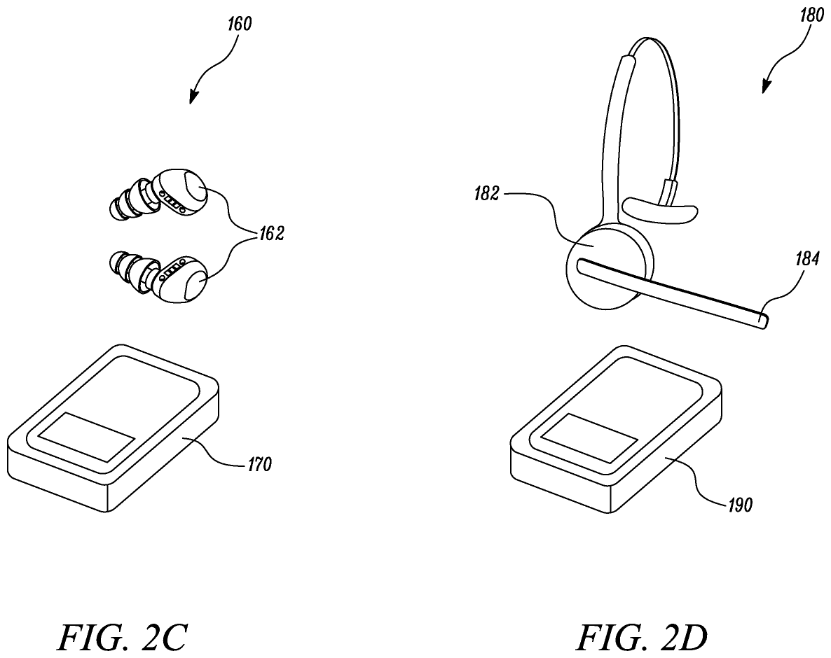

FIG. 2A illustrates a perspective view of the headset 110 according to an embodiment of the present disclosure. The headset 110 includes at least one earpiece 112 having one or more integrated speakers. The at least one earpiece 112 includes a first earpiece 112A and a second earpiece 112B. The first earpiece 112A includes one or more integrated speakers 116. The second earpiece 112B also includes one or more integrated speakers (not shown) similar to the one or more speakers 116 of the first earpiece 112A. The speakers 116 of the first and second earpieces 112A, 112B may be similar to each other in structure and in functionality. The headset 110 further includes at least one headband 117. The first and second earpieces 112A, 112B are interconnected through the at least one headband 117. In some examples, the headband 117 may resiliently hold the first and second earpieces 112A, 112B against user's ears. The headband 117 may include any rigid or semi-rigid material, such as plastic, aluminum, steel, or any other suitable material.

In some embodiments, each of the first earpiece 112A and the second earpiece 112B includes earmuffs. For example, the first and second earpieces 112A, 112B may include respective cushions 114A and 114B that are attached or otherwise affixed to the first and second earpieces 112A, 112B. The cushions 114A, 114B may engage around the ears of the user (e.g., the user 102) of the headset 110. The cushions 114A, 114B may contribute to the capability of the first and second earpieces 112A, 112B to dampen or otherwise reduce ambient sound from an environment (e.g., the ambient environment 104) outside the first and second earpieces 112A, 112B.

In some examples, the cushions 114A, 114B may include any compressible and/or expanding material, such as foam, gel, air, or any other suitable material. For example, the cushions 114A, 114B may be made of a gas filled cellular material that absorbs sound and attenuates noise, e.g., inhibits and preferably prevents sound waves, from reaching an ear canal of the user. The first and second earpieces 112A, 112B may include any rigid or semi-rigid material, such as a plastic, which in some cases, may be a non-conductive, dielectric plastic.

The speakers 116 of the first and second earpieces 112A, 112B may emit sound based on an analog or digital signal received or generated by the headset 110. In some examples, the speakers 116 may include one or more electroacoustic transducers that may convert electrical audio signals into sound. Some example speaker components may include a magnet, a voicecoil, a suspension, and a diaphragm or membrane. The speakers 116 may be communicatively coupled to a hardware (not shown) associated with each of the first and second earpieces 112A, 112B of the headset 110. In some examples, the hardware of the first and second earpieces 112A, 112B may be communicatively coupled to each other through a communication link 126.

The headset 110 further includes at least one microphone 118 coupled to the headset 110. The microphone 118 may be any device that converts sound into electrical audio signals. The microphone 118 may be communicatively and/or physically coupled to the hardware of the of the first and second earpieces 112A, 112B.

The headset 110 may further include a processor 120. In the illustrated embodiment of FIG. 2A, the processor 120 is disposed on the second earpiece 112B. However, the processor 120 may be associated with any one or both the first and second earpieces 112A, 112B. The hardware associated with the first and second earpieces 112A, 112B may be communicably coupled to the processor 120.

In some examples, the processor 120 may be embodied in a number of different ways. For example, the processor 120 may be embodied as various processing means, such as one or more of a microprocessor or other processing elements, a coprocessor, or various other computing or processing devices, including integrated circuits such as, for example, an ASIC (application specific integrated circuit), an FPGA (field programmable gate array), or the like. In some examples, the processor 120 may be configured to execute instructions stored in a memory or otherwise accessible to the processor 120. In some examples, the memory may include a cache or random-access memory for the processor 120. Alternatively, or in addition, the memory may be separate from the processor 120, such as a cache memory of a processor, a system memory, or other memory.

As such, whether configured by hardware or by a combination of hardware and software, the processor 120 may represent an entity (e.g., physically embodied in circuitry—in the form of processing circuitry) capable of performing operations according to some embodiments while configured accordingly. Thus, for example, when the processor 120 is embodied as an ASIC, FPGA, or the like, the processor 120 may have specifically configured hardware for conducting the operations described herein. Alternatively, as another example, when the processor 120 may be embodied as an executor of software instructions, the instructions may specifically configure the processor 120 to perform the operations described herein.

The headset 110 may further include a memory (not shown). In some examples, the memory may be configured to store data, such as user identification, device identification, headset operational data, software, audio data, etc. In some examples, the processor 120 may be configured to execute instructions stored in the memory or otherwise accessible to the processor 120. The functions, acts or tasks illustrated in the figures or described herein may be performed by the processor 120 executing the instructions stored in the memory. The functions, acts or tasks may be independent of a particular type of instruction set, a storage media, a processor or processing strategy and may be performed by a software, a hardware, an integrated circuit, a firmware, a micro-code and/or the like, operating alone or in combination. Likewise, the processing strategies may include multiprocessing, multitasking, parallel processing, and/or the like.

In some examples, the memory may be a main memory, a static memory, or a dynamic memory. The memory may include, but not limited to, computer readable storage media, such as various types of volatile and non-volatile storage media, including, but not limited to, random access memory, read-only memory, programmable read-only memory, electrically programmable read-only memory, electrically erasable read-only memory, flash memory, magnetic tape or disk, optical media, and/or the like.

The headset 110 further includes a user interface 124 communicably coupled to the processor 120. In some examples, the user interface 124 may include buttons, keys, actuators, lights, a display, a tactile input, etc., and may be able to receive inputs from the user of the headset 110. Additionally, the user interface 124 may be able to provide alerts to the user in a variety of ways, such as by sounding an alarm or vibrating. For example, the user interface 124 may be an audio interface that outputs tones, sounds or words as output. In some embodiments, the user interface 124 includes the at least one microphone 118 that receives spoken words or sounds. In some examples, the user interface 124 may receive other inputs, such as gestures and/or touch inputs.

The user interface 124 is configured to receive at least one input I from the user. In some embodiments, the at least one input I is indicative of a request for voice communication with at least one other headset (not shown). For example, the user of the headset 110 may press a button associated with the user interface 124 for requesting voice communication with the at least one other headset. The at least one other headset may be similar to the headset 110.

The headset 110 further includes a wireless communication interface 130 communicably coupled to the processor 120. The wireless communication interface 130 may include one or more antennas for receiving radio signals from the at least one other headset that is remote from the headset 110. In some examples, the wireless communication interface 130 may be configured to communicably couple the processor 120 with the at least one other headset. Specifically, the processor 120 may transmit and receive radio signals through the wireless communication interface 130. In some examples, the processor 120 may further be configured to process data received through the wireless communication interface 130.

In some examples, the headset 110 may facilitate two-way communication with the at least one other headset. In some examples, the two-way communication may include wired to wireless communication. In some examples, the two-way communication may include wireless radio communication. Further, the two-way communication may include digital or analog two-way communication. In some examples, the headset 110 may be configured to transmit and receive audio signals representing voice communication through the two-way communication.

In some examples, when the headset 110 receives an audio signal through the wireless communication interface 130, the speakers 116 may emit sound corresponding to the audio signal. The sound may be distributed between first and second earpieces 112A, 112B. Further, the microphone 118 may convert a sound of a speech of the user of the headset 110 into electrical audio signals. The electrical audio signals may then be received by the processor 120 via a communication link 122 and may be transmitted to the at least one other headset through the wireless communication interface 130.

In some examples, the wireless communication interface 130 may communicate data via one or more wireless communication protocols, such as Wi-Fi, Bluetooth®, infrared, Zigbee, wireless universal serial bus (USB), near-field communication (NFC), RFID protocols, or generally any wireless communication protocol. In some examples, data may be transmitted through a communication network. In some examples, the communication network may include one or more of a wireless network, a wired network, a local area network (LAN), a metropolitan area network (MAN), a wide area network (WAN), a wireless personal area network (WPAN), a mobile network, a Virtual Private Network (VPN), public switched telephone network (PSTN), 802.11, 802.16, 802.20, WiMax networks, and/or the like, and may include a set of interconnected networks that make up the Internet.

In some examples, a voice communication channel VC is established between the headset 110 and the at least one other headset through the wireless communication interface 130. The voice communication channel VC may allow voice communication between the headset 110 and the at least one other headset through the at least one microphone 118 or the user interface 124.

The processor 120 is configured to receive, via the user interface 124, the at least one input I from the user. In some embodiments, the at least one input I includes at least one of a voice input, a gesture-based input and a touch-based input. In some examples, the at least one input I includes pressing of a button (not shown). The at least one input I may indicate a request for voice communication by the user. For example, the user may press the button to connect the headset 110 with the at least one other headset.

The processor 120 is further be configured to generate, via the wireless communication interface 130, the voice communication channel VC between the headset 110 and the at least one other headset upon receiving the at least one input I. The voice communication channel VC may be a radio communication channel that may allow transfer of a voice or audio signal between the headset 110 and the at least one other headset. In some examples, the voice communication channel VC may include a bidirectional link that allows simultaneous transmission of audio signals from both ends of the voice communication channel VC.

The processor 120 is further configured to generate, through the voice communication channel VC, a voice communication session VS between the headset 110 and the at least one other headset. The voice communication session VS may be similar to a phone call where participants may communicate with each other through audio signals. In some embodiments, the voice communication session VS allows voice communication between the headset 110 and the at least one other headset in a full-duplex communication mode.

In some embodiments, the processor 120 is further configured to generate a first alert A1 upon generation of the voice communication session VS between the headset 110 and the at least one other headset. In some examples, the first alert A1 may indicate that the voice communication session VS has been initiated.

In some embodiments, the processor 120 is further configured to generate the voice communication channel VC as a direct wireless communication channel DC between the headset 110 and the at least one other headset. The direct wireless communication channel DC may allow direct radio communication between the headset 110 and the at least one other headset, such that the headset 110 may transmit and receive radio signals (e.g., audio signals) with the at least one other headset without an intermediate network. In some embodiments, the processor 120 is further configured to generate the voice communication channel VC between the headset 110 and the at least one other headset through the wireless local area network.

FIG. 2B illustrates a headset 160 according to another embodiment of the present disclosure. The headset 160 may be used in the system 100 of FIG. 1. The headset 160 includes at least one earpiece 162. The at least one earpiece 162 includes one or more integrated speakers (e.g., similar to the speaker 116 of FIG. 2A). In some embodiments, the at least one earpiece 162 is configured to be at least partly received in an ear of the user of the headset 160. Specifically, the at least one earpiece 162 has an earbud configuration. The headset 160 further includes an external device 170. The at least one earpiece 162 may be communicably coupled to the external device 170. In the illustrated embodiment of FIG. 2B, the at least one earpiece 162 is communicably coupled to the external device 170 using a physical communication link 172. The physical communication link 172 may include a wired connection. In some cases, the physical communication link may include a cable. Further, the headset 110 includes a pair of the earpieces 112 configured to be at least partly received in corresponding ears of the user.

In some examples, the external device 170 may include a processor (not shown) and a wireless communication interface (not shown). However, the processor and/or the wireless communication interface may be disposed on the at least one earpiece 162 as well. The external device 170 may further include a user interface (not shown) communicably coupled to the processor. In some examples, the user interface may be disposed on the at least one earpiece 162 or the external device 170. Further, the headset 160 includes at least one microphone (not shown) disposed either on the at least one earpiece 162 or the external device 170.

Referring to FIG. 2C, the headset 160 includes the at least one earpiece 162 wirelessly coupled to the external device 170. For example, the at least one earpiece 162 and the external device 170 may include separate wireless communication interfaces communicably coupled to each other through any suitable wireless communication protocol, such as Wi-Fi, Bluetooth®, infrared, Zigbee, wireless universal serial bus (USB), near-field communication (NFC), RFID protocols, or generally any wireless communication protocol.

FIG. 2D illustrates a headset 180 according to another embodiment of the present disclosure. The headset 180 may be used in the system 100 of FIG. 1. The headset 180 includes at least one earpiece 182. In the illustrated embodiment of FIG. 2D, the at least one earpiece 182 includes a single earpiece 182. The headset 180 further includes an external device 190. The at least one earpiece 182 may be communicably coupled to the external device 190 through any wired or wireless communication interface. The headset 180 further incudes at least one microphone 184 couped to the at least one earpiece 182. In the illustrated example of FIG. 2D, the headset 180 may or may not provide hearing protection to the user (e.g., the user 102 shown in FIG. 1) of the headset 180.

It should be understood that the configurations of the headsets 110, 160, 180, as illustrated in FIGS. 2A-2D, are exemplary in nature, and the configurations of the headsets 110, 160, 180 may vary based on application requirements. For example, the headsets 110, 160, 180 may include any type of audio headsets including, but not limited to, headphones (including bone-conduction headphones), over-the-ear headphones, earbuds, earbud-type headphones with ear hooks, in-ear headphones that extend at least partially into an ear canal, etc.

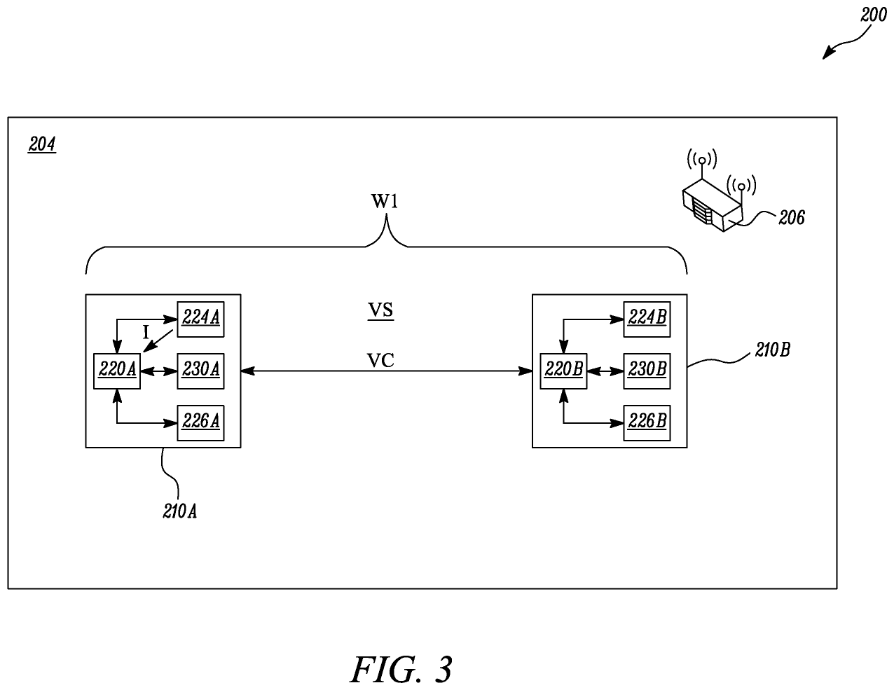

FIG. 3 is a block diagram illustrating a system 200 according to an embodiment of the present disclosure. The system 200 includes a first headset 210A including a processor 220A and a wireless communication interface 230A. The system 200 further includes at least one second headset 210B. The at least one second headset 210B includes a processor 220B and a wireless communication interface 230B. In some embodiments, the first headset 210A and the at least one second headset 210B may be similar to the headset 110 of FIGS. 1 and 2A. In some other embodiments, each of the headsets 210A, 210B may be similar to at least one of the headsets 160, 180 illustrated in FIGS. 2B, 2C and 2D.

The first headset 210A and the at least one second headset 210B may be a part of an ambient environment 204. The ambient environment 204 may be similar to the ambient environment 104 of FIG. 1. The system 200 may include a communication network (e.g., a wireless local area network) through which the first headset 210A and the at least one second headset 210B may communicate.

Examples of communication network may include one or more of a wireless network, a wired network, a local area network (LAN), a metropolitan area network (MAN), a wide area network (WAN), a wireless personal area network (WPAN), WiMax networks, cellular network, a direct connection, such as through a Universal Serial Bus (USB) port, and/or the like, and may include a set of interconnected networks that make up the Internet. Further, the ambient environment 204 may include one or more wireless access points 206 that may be geographically distributed throughout the ambient environment 204 to provide support for wireless communication throughout the ambient environment 204.

The first headset 210A and the at least one second headset 210B may include respective user interfaces 224A, 224B (e.g., the user interface 124) for receiving the at least one input I from users of the first headset 210A and the at least one second headset 210B. In some examples, the user interfaces 224A, 224B may be communicably coupled to the respective processors 220A, 220B of the first headset 210A and the at least one second headset 210B. Further, the first headset 210A and the at least one second headset 210B may include respective memories 226A, 226B. In some examples, the processors 220A, 220B of the first headset 210A and the at least one second headset 210B may include one or more analog or digital signal processors for performing signal processing functions on transmitted and received radio signals.

In some examples, the processor 220A of the first headset 210A may be configured to receive the at least one input I from the user (e.g., the user 102 of FIG. 1) of the first headset 210A. Specifically, the user interface 224A of the first headset 210A may receive the at least one input I from the user of the first headset 210A. The at least one input I may be indicative of a request for voice communication with the at least one second headset 210B. For example, the user of the first headset 210A may provide the least one input I when the user wishes to communicate with the at least one second headset 210B. Thus, the first headset 210A and the at least one second headset 210B may facilitate voice communication between the respective users of the first headset 210A and the at least one second headset 210B. In some examples, the first headset 210A and the at least one second headset 210B may be equipped with one or more microphones (e.g., the microphone 118 shown in FIG. 2A) that allows users to communicate with each other through respective headsets.

In some examples, the at least one input I includes at least one of a voice input, a gesture-based input and a touch-based input. In some examples, the user interface 224A associated with the first headset 210A may include the microphone (e.g., the microphone 118) configured to receive the voice input from the user of the first headset 210A. For example, the user may provide the voice input such as “Call John” to connect with a person named John. In some examples, the first headset 210A may only communicate within a workgroup W1. In other words, the user of the first headset 210A may be able to communicate with the person named John in the same workgroup as that of the user. As used herein, the term “workgroup” refers to a cluster of headsets grouped together based on predetermined set of rules or instructions. For example, the workgroup W1 may include headsets working together in a same team or a region.

In some examples, the processor 220A may perform speech recognition on the voice input received through the user interface 224A. In some examples, the processor 220A may perform speech recognition functions to process and analyze the voice input. More particularly, the processor 220A may detect the voice input and identify words, terms and/or phrases spoken by the user based on the voice input. In some examples, the processor 220A may utilize automatic speech recognition (ASR), computer speech recognition, or speech to text (STT) to translate voice input into text that is readable by the processor 220A. For example, the processor 220A may utilize acoustic and language modelling techniques, such as, for example, Hidden Markov models (HMV), Dynamic Time Warping (DTW), Natural Language Processing, and Neural Networks for translation of voice input to text.

In some examples, the processor 220A may analyze the speech contained in the voice input to identify the context of the utterances spoken by the user, and use this context to identify operational inputs (e.g., the word “Call”) and the name of contact whom the user wishes to contact in the workgroup W1. For example, the processor 220A may process information generated through speech recognition to identify a name, or a portion of a name, contained in the voice input and the context of the voice input to identify one or more contacts in the workgroup W1. In some examples, if the voice input includes a spoken utterance of the word “Call” and a spoken utterance of the name “John”, the processor 220A may perform the intended functions to generate the voice communication channel VC with a headset assigned to a person named “John”. In some examples, such instructions and names may be stored in the memory 226A of the first headset 210A.

Similarly, the user may provide the gesture-based input and/or the touch-based input through the first headset 210A to request for communication with the at least one second headset 210B. For example, the user may touch a portion of the user interface 224A for providing the at least one input I. In some embodiments, the user may provide the gesture-based input through hands of the user. However, in some other embodiments, the user may provide the gesture-based input through any deliberate body motion.

The processor 220A is further configured to generate, via the wireless communication interface 230A, the voice communication channel VC between the first headset 210A and the at least one second headset 210B upon receiving the at least one input I. The wireless communication interface 230A preferably uses radio transmission to establish the voice communication channel VC. The voice communication channel VC may allow transmission and reception of audio signals between the first headset 210A and the at least one second headset 210B.

In some embodiments, the processor 220A is further configured to generate the voice communication channel VC between the first headset 210A and the at least one second headset 210B through the wireless local area network. The processor 220A may access the wireless area network through the one or more wireless access points 206. In some examples, the wireless local area network may enable voice communication between the first headset 210A and the at least one second headset 210B through VoIP (Voice over Internet Protocol).

The processor 220A is further configured to generate, through the voice communication channel VC, the voice communication session VS between the first headset 210A and the at least one second headset 210B. Specifically, the user of the first headset 210A may provide the at least one input I to the first headset 210A and the first headset 210A may generate the voice communication session VS through the voice communication channel VC. For example, the user may provide voice input “Call John” to connect with a headset of a person named John. Such an arrangement may facilitate hands-free communication through the first headset 210A. The voice communication session VS may allow voice communication between the first headset 210A and the at least one second headset 210B in the full-duplex communication mode. It should be understood that the voice communication channel VC may be generated by any of the first headset 210A and the at least one second headset 210B.

In some embodiments, the processor 220A is further configured to generate a first alert A1 upon generation of the voice communication session VS between the first headset 210A and the at least one second headset 210B. In some embodiments, the first alert A1 includes at least one of an audible alert and a haptic alert. For example, the first headset 210A and the at least one second headset 210B may provide the audible alert through the one or more integrated speakers (e.g., the speakers 116 of FIG. 2A) upon generation of the voice communication session VS. The first alert A1 may indicate that the voice communication session VS has been initiated.

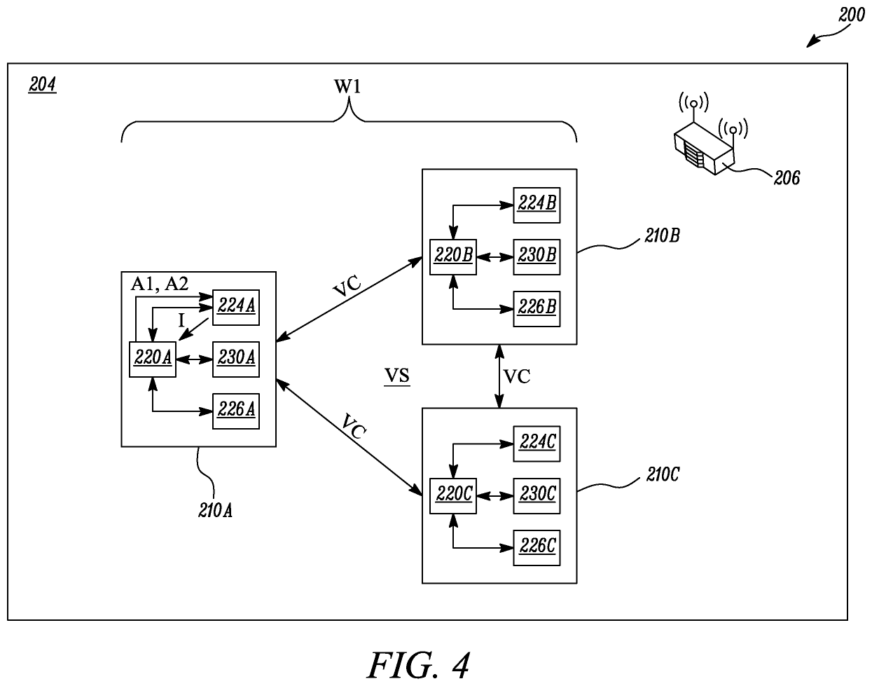

FIG. 4 is a block diagram illustrating the system 200 according to another embodiment of the present disclosure. In the illustrated example of FIG. 4, the at least one second headset 210B includes a plurality of second headsets 210B-210N (collectively, the plurality of second headsets 210B). Only the second headsets 210B, 210C are shown in FIG. 4 for the purpose of illustration. However, there may be other second headsets 210B-210N present in the system 200. The second headset 210C may be similar to the first headset 210A. The second headset 210C includes a processor 220C, a user interface 224C, a wireless communication interface 230C, and a memory 226C. Each of the first headset 210A and the second headsets 210B, 210C may be associated with a corresponding user (not shown).

The first headset 210A and the plurality of second headsets 210B may facilitate voice communication between the respective users of the first headset 210A and the plurality of second headsets 210B. In some examples, each of the first headset 210A and the plurality of second headsets 210B may be equipped with a microphone (e.g., the microphone 118 of FIG. 2A) that allows users to communicate with each other through the respective headsets 210.

In some embodiments, the first headset 210A and the plurality of second headsets 210B, 210C form the workgroup W1. In some examples, the processor 220A of the first headset 210A may be configured to receive the at least one input I from the user of the first headset 210A. The at least one input I may be indicative of a request for voice communication with the plurality of second headsets 210B. In some examples, the at least one input I may include pressing of a button (not shown). The user interface 224A may include one or more buttons through which the user may provide the at least one input I. Pressing the button may automatically generate the voice communication channel VC with the entire workgroup W1. Such a feature may be helpful when the entire workgroup W1 needs to be contacted. It should be understood that any user in the workgroup W1 may provide the at least one input I through the associated headset for contacting the workgroup W or any contact in the workgroup WI.

In some embodiments, the at least one input I includes at least one of the voice input, the gesture-based input and the touch-based input for contacting the entire workgroup WI. For example, the users may provide the voice input, such as “Call Project Twin”, to connect with all the headsets associated with that workgroup. In some examples, the voice input may be used to contact all the headsets associated with a particular region. For example, the users may provide the voice input, such as “Call Lab Area” or “Broadcast Local Area”, to communicate with all the headsets in that area. For example, the users may need to broadcast a safety message to all the individuals working in a particular area.

In some examples, the processors 220A-220C may analyze and process the speech contained in the voice input to identify the workgroup W1 or area. For example, if the voice input includes a spoken utterance of the word “Call” or “Broadcast” and a spoken utterance of the name “Lab Area”, the processor 220A may generate the voice communication channel VC with all the headsets (e.g., the first headset 210A and the plurality of second headsets 210B) in the workgroup named “Lab Area”.

It should be understood that the examples of the at least one input above are described by way of example only, and the at least one input may vary based on application requirements.

In some examples, the workgroup W1 may be managed by a remote server (not shown). One or more workgroups WI may be modified or generated by one or more authorized managers responsible for overseeing the ambient environment 204. In some examples, the workgroup WI may be managed by a user interface device, such as a smartphone or any other mobile terminal/computing device through a software application.

In some embodiments, the processor 220A is further configured to generate the voice communication channel VC between the first headset 210A and the plurality of second headsets 210B in the workgroup W1. In the illustrated example of FIG. 4, the voice communication channel VC is generated between the first headset 210A and the second headsets 210B, 210C.

In some embodiments, the processor 220A is further configured to generate the voice communication session VS between the first headset 210A and the plurality of second headsets 210B in the workgroup W1, such that the voice communication session VS allows voice communication in the full-duplex communication mode within the workgroup W1. In the example discussed above, the voice communication channel VC is generated by the first headset 210A, however, it should be understood that the voice communication channel VC may be generated by any headset within the workgroup W1.

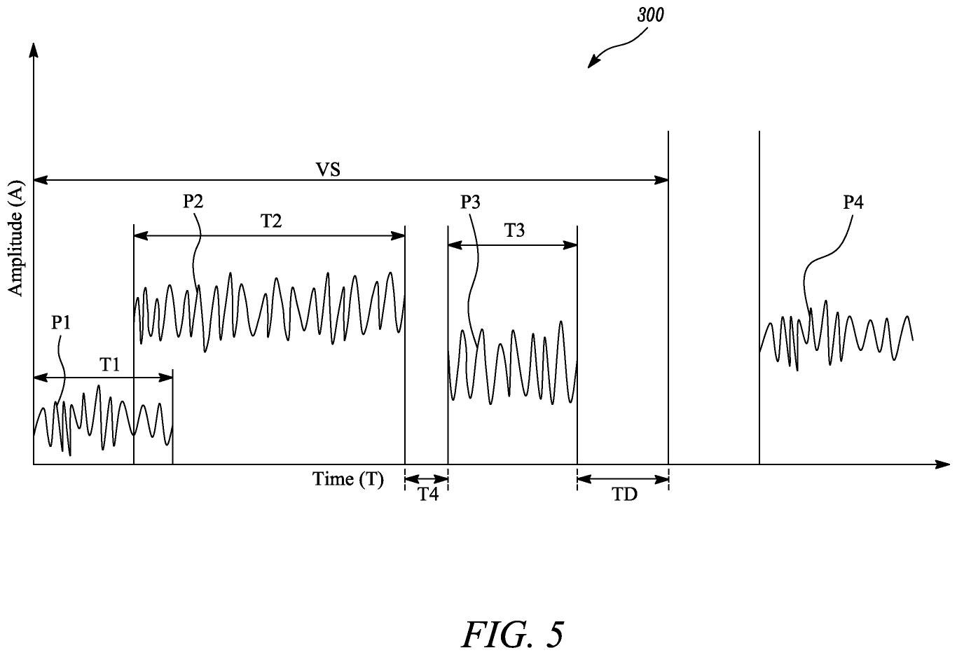

FIG. 5 illustrates an exemplary plot 300. Referring to FIGS. 4 and 5, the plot 300 illustrates voice communication between the first headset 210A and the second headsets 210B, 210C. The processor 220A of the first headset 210A may generate the voice communication session VS between the first headset 210A and the second headsets 210B, 210C through the voice communication channel VC. The vertical axis or ordinate of the plot 300 may represent amplitude A of an audio signal transmitted through the voice communication session VS and the horizontal axis may represent time duration for transmission of the audio signal. In some examples, the plot 300 may represent voice communication between the first headset 210A and the second headsets 210B, 210C anytime during the voice communication session VS.

An audio signal P1 may correspond to an audio signal generated from the first headset 210A during the voice communication session VS for a time duration T1. An audio signal P2 may correspond to an audio signal generated from the second headset 210B during the voice communication session VS for a time duration T2. An audio signal P3 may correspond to an audio signal generated from the second headset 210C during the voice communication session VS for a time duration T3. The voice communication session VS may allow voice communication in the full-duplex communication mode such that all the headsets 210A, 21B, 210C at the end of the voice communication channel VC may be able to transmit audio signals simultaneously through their respective headsets. Hence, there may be an overlap between the time duration T1 and the time duration T2 of the audio signal P1 and the audio signal P2, respectively.

In some embodiments, the processor 220A is further configured to determine a time duration T elapsed since a termination of a last voice communication in the voice communication session VS. Specifically, the time duration T may start from the termination of the last audio signal transmitted through the voice communication session VS. In the illustrated plot 300 of FIG. 4, the audio signal P3 may represent the last audio signal transmitted through the voice communication session VS. The processor 220A may include one or more signal processors for determining last voice communication.

In some embodiments, the processor 220A is further configured to terminate the voice communication session VS in response to the time duration T exceeding a predetermined time threshold TD. Generally, there may be a certain time duration elapsed between subsequent audio signals in the voice communication session VS, however, the voice communication session VS is only terminated when the time duration elapsed since the termination of the last voice communication (e.g., the audio signal P3) in the voice communication session VS exceeds the predetermined time threshold TD. In other words, the voice communication session VS is not terminated after the audio signal P2 since the time duration T4 between the audio signal P2 and the audio signal P3 is less than the predetermined time threshold TD (i.e., T4<TD). However, the voice communication session VS is terminated after the predetermined time threshold TD has elapsed after termination of the audio signal P3.

In some examples, the predetermined time threshold TD may be stored in the memories 226A-226C of the respective headsets. In some examples, the predetermined time threshold TD may be subjected to modification based on application requirements. It should be understood that the time duration T since the last voice communication may be determined by any of the processors 220A-220C. Further, each processor 220A-220C may calculate the time duration T since the last voice communication independently.

Referring now to FIGS. 3, 4 and 5, the processor 220A is further configured to generate a second alert A2 upon termination of the voice communication session VS. In some examples, the second alert A2 may include at least one of an audible alert and a haptic alert. For example, the first headset 210A and the second headsets 210B, 210C may generate the audible alert through the at least one integrated speaker (e.g., the speaker 116 of FIG. 2A) upon termination of the voice communication session VS. In some examples, the audible alert may include a beep sound or a chime. In some examples, the second alert A2 may be different from the first alert A1.

After the termination of the voice communication session VS, a subsequent voice communication session may be generated through another voice communication channel VC upon reception of the at least one input I through the first headset 210A or the second headsets 210B, 210C. For example, an audio signal P4 may be generated by the second headset 210B upon generation of a subsequent voice communication session.

It should be understood that the voice communication session VS may also be generated between only two headsets (e.g., the first headset 210A and the second headset 210B). Such a voice communication session may be terminated upon lapse of the predetermined time duration TD from the last voice communication received through any of the associated headsets.

It should be understood that the plot 300 is shown by way of example only, and the audio signals associated with the voice communication session VS may vary based on communication between the headsets.

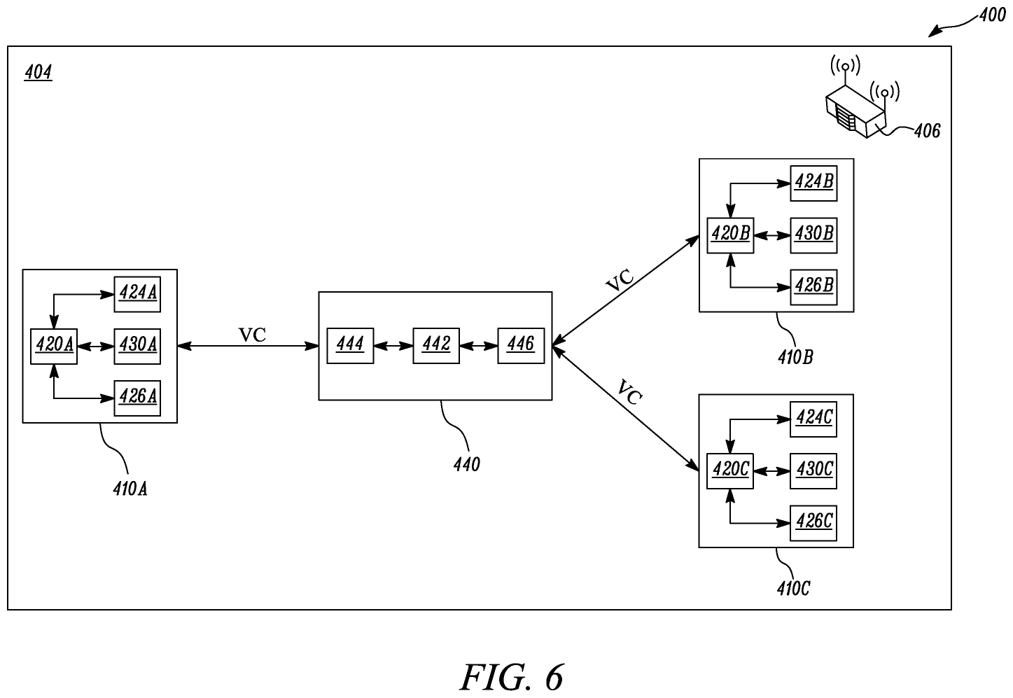

FIG. 6 is a block diagram illustrating a system 400 according to an embodiment of the present disclosure. The system 400 may be similar to the system 200 of FIGS. 3 and 4 and equivalent reference numbers are used to designate same or similar elements. Referring to FIGS. 3-6, the system 400 includes a first headset 410A including a processor 420A and a wireless communication interface 430A. The system 400 further includes at least one second headset 410B including a processor 420B and a wireless communication interface 430B. The at least one second headset 410B includes a plurality of second headsets 410B-410N (collectively, the plurality of second headsets 410B). Only the second headsets 410B, 410C are shown in FIG. 4 for the purpose of illustration. However, there may be other second headsets 410B-410N present in the system 400.

The second headset 410C includes a processor 420C and a wireless communication interface 430C. The first headset 410A and the plurality of second headsets 410B may be similar to each other. In some examples, the first headset 410A and the second headsets 410B, 410C may form the workgroup W1. The first headset 410A and plurality of second headsets 410B may be a part of an ambient environment 404.

The system 400 may further include a communication controller 440 (e.g., the communication controller 108 of FIG. 1) communicably coupled to the first headset 410A and the plurality of second headsets 410B. The communication controller 440 may include a control unit 442 communicably coupled to a memory 444 and a wireless communication interface 446.

In some examples, the workgroup W1 may be managed by the communication controller 440. For example, the communication controller 440 may store predefined workgroups located within the ambient environment 404 in the memory 444. In some examples, the communication controller 440 may allow generation of new workgroups. In some examples, the communication controller 440 may permit new users to be added to the workgroup W1. Further, the communication controller 440 may authorize voice communication within the workgroup W1.

The system 400 may include a communication network (e.g., a wireless local area network) through which the first headset 410A and the plurality of second headsets 410B may communicate. Further, the ambient environment 404 may include one or more wireless access points 406 that may be geographically distributed throughout the ambient environment 404.

The first headset 410A and the second headsets 410B, 410C may further include respective user interfaces 424A, 424B and 424C for receiving the at least one input I from the respective users. The first headset 410A and the second headsets 410B, 410C may further include respective memories 426A, 426B, 426C. In some examples, the processors 420A, 426B, 420C may include one or more analog or digital signal processors for performing signal processing functions on the transmitted and received audio signals.

In some embodiments, the processor 420A of the first headset 410A may be configured to receive the at least one input I from the user of the first headset 410A. Specifically, the user interface 424A of the first headset 410A may receive the at least one input I. The at least one input I may be indicative of a request for voice communication with the at least one second headset 410B or the plurality of second headsets 410B.

In some embodiments, the processor 420A is further configured to generate, via the wireless communication interface 430A, the voice communication channel VC between the first headset 410A and the plurality of second headsets 410B upon receiving the at least one input I. In some embodiments, the processor 420A is further configured to generate the voice communication channel VC between the first headset 410A and the at least one second headset 410B through the communication controller 440. In the illustrated example of FIG. 6, the voice communication channel VC is generated between the communication controller 440, and the first headset 410A and the second headsets 410B, 410C. The communication controller 440 may be a part of the wireless local area network that may support generation of the voice communication channel VC. Further, the communication controller 440 may authorize generation of the voice communication channel VC.

In some embodiments, the processor 420A is further configured to generate, through the voice communication channel VC, the voice communication session VS between the first headset 410A and the plurality of second headsets 410B. In some embodiments, the communication controller 440 is configured to determine the time duration T elapsed since a termination of a last voice communication in the voice communication session VS. Specifically, the control unit 442 may determine the time duration T elapsed since a termination of the last voice communication and manage the voice communication session VS accordingly.

In some embodiments, the communication controller 440 is further configured to terminate the voice communication session VS in response to the time duration T exceeding the predetermined time threshold TD. In some examples, the processors 420A-420C and/or the communication controller 440 may determine the time duration T elapsed since the termination of the last voice communication in the voice communication session VS and terminate the voice communication session VS in response to the time duration T exceeding the predetermined time threshold TD.

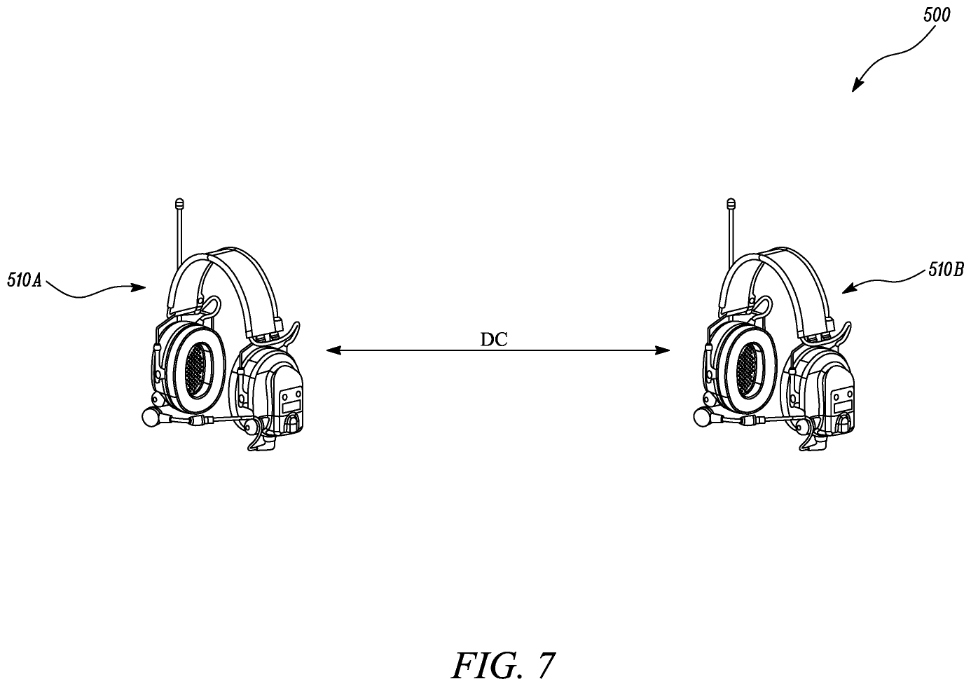

FIG. 7 illustrates a system 500 according to an embodiment of the present disclosure. The system 500 includes a first headset 510A and at least one second headset 510B. The first headset 510A and at least one second headset 510B may be similar to the headset 110 of FIGS. 1 and 2A. The first headset 510A and at least one second headset 510B may include respective processors (not shown) and wireless communication interfaces (not shown). It should be understood that the configuration of the first headset 510 and the at least one second headset 510B, as illustrated in FIG. 7, may vary based on the application requirements. In some examples, the first headset 510 and/or the at least one second headset 510B may include any type of headset as described above.

Referring to FIGS. 3-7, the processor of the first headset 510A may be configured to receive the at least one input I from a user of the first headset 510A. The at least one input I is indicative of a request for voice communication with the at least one second headset 510B. The processor of the first headset 510A is further configured to generate, via the wireless communication interface, a voice communication channel VC1 between the first headset 510A and the at least one second headset 510B upon receiving the at least one input I.

In some embodiments, the processor of the first headset 510A is further configured to generate the voice communication channel VC1 as the direct wireless communication channel DC between the first headset 510A and the at least one second headset 510B. The direct wireless communication channel DC may allow direct data transmission between the first headset 510A and the at least one second headset 510B, such that the first headset 510A and the at least one second headset 510B may communicate directly with each other through radio signals. The wireless communication interfaces of the first headset 510A and the at least one second headset 510B may be equipped with respective transceivers to allow direct exchange of radio signals through the voice communication channel VC1.

In some embodiments, the processor of the first headset 510A is further configured to generate, through the voice communication channel VC1, a voice communication session VS1 between the first headset 510A and the at least one second headset 510B. In some embodiments, the voice communication session VS1 allows voice communication between the first headset 510A and the at least one second headset 510B in the full-duplex communication mode.

In some embodiments, the processor of the first headset 510A is further configured to determine the time duration T elapsed since a termination of a last voice communication in the voice communication session VS1. In some embodiments, the processor of the first headset 510A is further configured to terminate the voice communication session VS1 in response to the time duration T exceeding the predetermined time threshold TD.

It should be understood that the voice communication channel VC1 may be generated by any one of the first headset 510A and the at least one second headset 510B. The time duration T may also be determined by both the first headset 510A and the at least one second headset 510B.

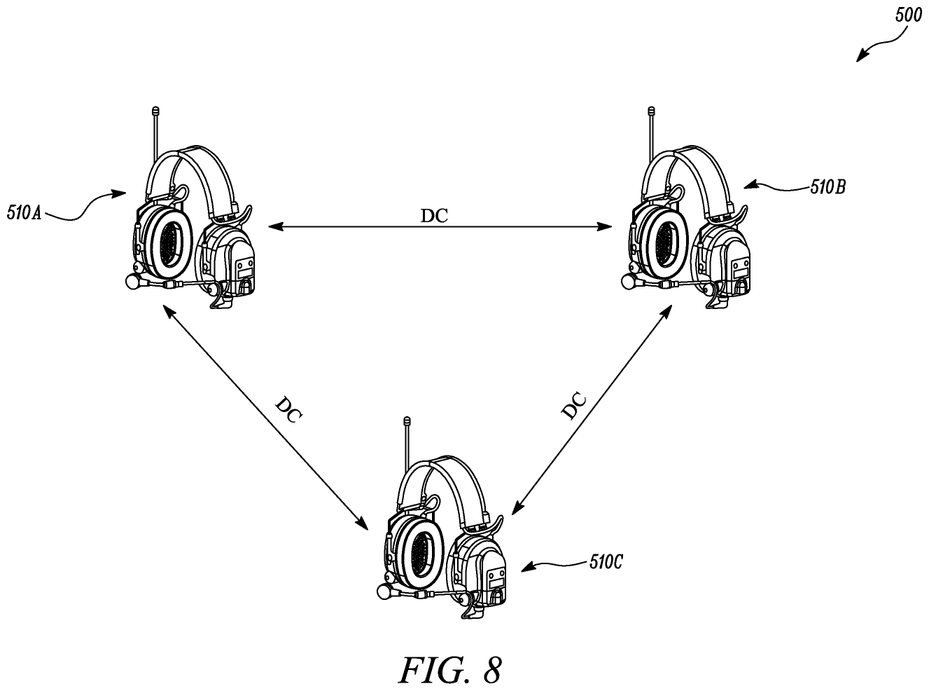

FIG. 8 is a block diagram illustrating another embodiment of the system 500. In the illustrated embodiment of FIG. 8, the at least one second headset 510B may include a plurality of second headsets 510B-510N (collectively, the plurality of second headsets 510B). Only the second headsets 510B, 510C are shown in FIG. 8 for the purpose of illustration. However, there may be other second headsets 510B-510N present in the system 500. In some examples, the second headsets 510B, 510C may be similar to the first headset 510A.

It should be understood that the configuration of the first headset 510 and the second headsets 510B, 510C, as illustrated in FIG. 8, may vary based on the application requirements. In some examples, the first headset 510 and/or the second headsets 510B, 510C may include any type of headset as described above.

The first headset 510A and the plurality of second headsets 510B may form a workgroup W2. In some embodiments, the processor 520A is further configured to generate the voice communication channel VC1 between the first headset 510A and the plurality of second headsets 510B in the workgroup W2 upon receiving the at least one input I from the user of the first headset 510A. In some embodiments, the voice communication channel VC1 may be the direct wireless communication channel DC between the first headset 510A and the plurality of second headsets 510B. It should be understood that the voice communication channel VC1 may be generated by any headset within the workgroup W2.

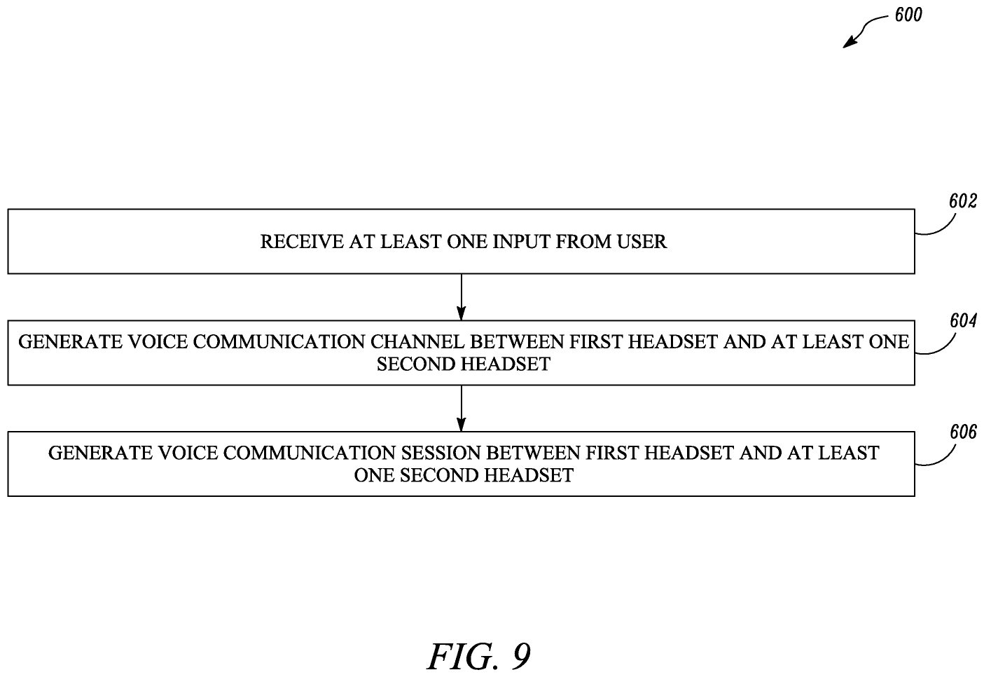

FIG. 9 is a flow chart illustrating a method 600 of communicating. The method 600 may be implemented using any one of the systems 100, 200, 400, 500 of FIGS. 1, 3-4, and 6-8.

At step 602, the method 600 includes receiving, at the first headset 210A, 410A, 510A, the at least one input I from the user (e.g., the user 102 of FIG. 1). The at least one input I is indicative of a request for voice communication with the at least one second headset 210B, 410B, 510B. In some embodiments, the at least one input I includes at least one of a voice input, a gesture-based input and a touch-based input. In some embodiments, the at least one input I includes pressing of a button.

At step 604, the method 600 further includes generating, via the first headset 210A, 410A, 510A, the voice communication channel VC, VC1 between the first headset 210A, 410A, 510A and the at least one second headset 210B, 410B, 510B upon receiving the at least one input I. In some embodiments, the voice communication channel VC, VC1 between the first headset 210A, 410A, 510A and the at least one second headset 210B, 410B, 510B is generated through a wireless local area network. In some embodiments, the voice communication channel VC, VC1 is the direct wireless communication channel DC between the first headset 210A, 410A, 510A and the at least one second headset 210B, 410B, 510B.

In some embodiments, the at least one second headset 210B, 410B, 510B includes a plurality of second headsets 210B-210N, 410B-410N, 510B-510N (collectively, the plurality of second headsets 210B, 410B, 510B). In some embodiments, the first headset 210A, 410A, 510A and the plurality of second headsets 210B, 410B, 510B form the workgroup W1, W2. In some embodiments, the voice communication channel VC, VC1 is generated between the first headset 210A, 410A, 510A and the plurality of second headsets 210B, 410B, 510B in the workgroup W1, W2.

At step 606, the method 600 further includes generating, through the voice communication channel VC, VC1, the voice communication session VS, VS1 between the first headset 210A, 410A, 510A and the at least one second headset 210B, 410B, 510B. The voice communication session allows voice communication between the first headset 210A, 410A, 510A and the at least one second headset 210B, 410B, 510B in the full-duplex communication mode.

In some embodiments, the voice communication session VS, VS1 is generated between the first headset 210A, 410A, 510A and the plurality of second headsets 210B, 410B, 510B in the workgroup W1, W2, such that the voice communication session VS, VS1 allows voice communication in the full-duplex communication mode within the workgroup WI, W2.

In some embodiments, the method 600 further includes generating the first alert A1 upon generation of the voice communication session VS, VS1 between the first headset 210A, 410A, 510A and the at least one second headset 210B, 410B, 510B. In some embodiments, the first alert A1 includes at least one of an audible alert and a haptic alert.

In some embodiments, the method 600 further includes determining the time duration T elapsed since a termination of a last voice communication in the voice communication session VS, VS1. In some embodiments, the method 600 further includes terminating the voice communication session VS, VS1 in response to the time duration T exceeding the predetermined time threshold TD.

In some embodiments, the method 600 further includes generating the second alert A2 upon termination of the voice communication session VS, VS1. In some embodiments, the second alert A2 includes at least one of an audible alert and a haptic alert.

The user of the first headset 210A, 410A, 510A may provide the at least one input I when the user wishes to connect with the at least one second headset 210B, 410B, 510B. Thus, the user may deliberately open the voice communication channel VC, VC1 between the first headset 210A, 410A, 510A and the at least one second headset 210B, 410B, 510B. This may prevent any unintentional transmission of speech. By deliberately opening the voice communication channel VC, VC1, a full portion of a speech of the user may be transmitted through the voice communication channel VC, VC1 as compared to communication devices that operate through VOX. Further, the termination of the voice communication session VS, VS1 in response to the time duration T exceeding the predetermined time threshold TD may prevent any accidental transmission of speech through the voice communication session VS, VS1.

The at least one input I may include a voice input by the user. This may enable communication between the first headset 210A, 410A, 510A and the at least one second headset 210B, 410B, 510B without the need for manual intervention as compared to PTT-based communication systems. Hence, the method 600 may allow hands-free communication between the first headset 210A, 410A, 510A and the at least one second headset 210B, 410B, 510B.

The full-duplex communication mode may facilitate communication between the first headset 210A, 410A, 510A and the at least one second headset 210B, 410B, 510B since a user of the at least one second headset may not need to manually open a transmission channel of the at least one second headset.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including, but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below, or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A method of communicating, comprising:
receiving, at a first headset, at least one input from a user, wherein the at least one input is indicative of a request for voice communication with at least one second headset;
generating, via the first headset, a voice communication channel between the first headset and the at least one second headset upon receiving the at least one input; and
generating, through the voice communication channel, a voice communication session between the first headset and the at least one second headset, wherein the voice communication session allows voice communication between the first headset and the at least one second headset in a full-duplex communication mode.

2. The method of claim 1, wherein the voice communication channel is a direct wireless communication channel between the first headset and the at least one second headset.

3. The method of claim 1, wherein the voice communication channel between the first headset and the at least one second headset is generated through a wireless local area network.

4. The method of claim 1, wherein the at least one second headset comprises a plurality of second headsets, wherein the first headset and the plurality of second headsets form a workgroup, and wherein the voice communication channel is generated between the first headset and the plurality of second headsets in the workgroup.

5. (canceled)

6. The method of claim 1, further comprising generating a first alert upon generation of the voice communication session between the first headset and the at least one second headset.

7. (canceled)

8. The method of claim 1, further comprising:
determining a time duration elapsed since a termination of a last voice communication in the voice communication session; and
terminating the voice communication session in response to the time duration exceeding a predetermined time threshold.

9-12. (canceled)

13. A system comprising:
a first headset comprising a processor and a wireless communication interface; and
at least one second headset;
wherein the processor of the first headset is configured to:
receive at least one input from a user, wherein the at least one input is indicative of a request for voice communication with the at least one second headset;
generate, via the wireless communication interface, a voice communication channel between the first headset and the at least one second headset upon receiving the at least one input; and
generate, through the voice communication channel, a voice communication session between the first headset and the at least one second headset, wherein the voice communication session allows voice communication between the first headset and the at least one second headset in a full-duplex communication mode.

14. The system of claim 13, wherein the processor is further configured to generate the voice communication channel as a direct wireless communication channel between the first headset and the at least one second headset.

15. The system of claim 13, wherein the processor is further configured to generate the voice communication channel between the first headset and the at least one second headset through a wireless local area network.

16. The system of claim 13, wherein the at least one second headset comprises a plurality of second headsets, wherein the first headset and the plurality of second headsets form a workgroup, and wherein the processor is further configured to generate the voice communication channel between the first headset and the plurality of second headsets in the workgroup.

17-19. (canceled)

20. The system of claim 13, wherein the processor is further configured to:
determine a time duration elapsed since a termination of a last voice communication in the voice communication session; and
terminate the voice communication session in response to the time duration exceeding a predetermined time threshold.

21-22. (canceled)

23. The system of claim 13, further comprising a communication controller communicably coupled to the first headset and the at least one second headset, wherein the processor is further configured to generate the voice communication channel between the first headset and the at least one second headset through the communication controller, and wherein the communication controller is configured to:
determine a time duration elapsed since a termination of a last voice communication in the voice communication session; and
terminate the voice communication session in response to the time duration exceeding a predetermined time threshold.

24-25. (canceled)

26. A headset comprising:
at least one earpiece comprising one or more integrated speakers;
at least one microphone coupled to the headset;
a processor;
a user interface communicably coupled to the processor, the user interface configured to receive at least one input from a user, wherein the at least one input is indicative of a request for voice communication with at least one other headset; and
a wireless communication interface communicably coupled to the processor, wherein the wireless communication interface is configured to communicably couple the processor with the at least one other headset;
wherein the processor is configured to:
receive, via the user interface, the at least one input from the user;
generate, via the wireless communication interface, a voice communication channel between the headset and the at least one other headset upon receiving the at least one input; and
generate, through the voice communication channel, a voice communication session between the headset and the at least one other headset, wherein the voice communication session allows voice communication between the headset and the at least one other headset in a full-duplex communication mode.

27. The headset of claim 26, wherein the at least one earpiece is configured to be at least partly received in an ear of the user.

28. The headset of claim 26, further comprising at least one headband, wherein the at least one earpiece comprises a first earpiece and a second earpiece, and wherein the first earpiece and the second earpiece are interconnected through the at least one headband.

29. (canceled)

30. The headset of claim 26, wherein the user interface comprises the at least one microphone.

31. The headset of claim 26, wherein the processor is further configured to generate the voice communication channel as a direct wireless communication channel between the headset and the at least one other headset.

32. The headset of claim 26, wherein the processor is further configured to generate the voice communication channel between the headset and the at least one other headset through a wireless local area network.

33. The headset of claim 26, wherein the processor is further configured to generate a first alert upon generation of the voice communication session between the headset and the at least one other headset.

34. (canceled)

35. The headset of claim 26, wherein the processor is further configured to:
determine a time duration elapsed since a termination of a last voice communication in the voice communication session; and
terminate the voice communication session in response to the time duration exceeding a predetermined time threshold.
